(19) United States
(12) Patent Application Publication
(10) Pub. No.: US 2008/0082928 A1
(43) Pub. Date: Apr. 3, 2008

(54) METHOD FOR VIEWING INFORMATION IN A COMMUNICATION DEVICE

(75) Inventors: EDWARD WALTER, BOERNE, TX (US); LARRY B. PEARSON, SAN ANTONIO, TX (US)

Correspondence Address: AKERMAN SENTERFITT, P.O. BOX 3188, WEST PALM BEACH, FL, 33402-3188, US

(73) Assignee: SBC KNOWLEDGE VENTURES, L.P., RENO, NV (US)

(21) Appl. No.: 11/536,748

(22) Filed: Sep. 29, 2006

(51) Int. Cl. G06F 3/00; G06F 9/00; G06F 17/00

(52) U.S. Cl. 715/764

(57) ABSTRACT

A method for viewing information in a communication device is disclosed. An apparatus that incorporates teachings of the present disclosure may include, for example, a communication device having a communication element that supports Voice over IP (VoIP) communications with a communication system, a User Interface (UI) element that presents a plurality of Graphical User Interface (GUI) elements for controlling operations of the communication device, and a navigation element that performs non-linear navigation between GUI elements presented by the UI element in response to detecting one or more navigation conditions. Additional embodiments are disclosed.

### FIELD OF THE DISCLOSURE

The present disclosure relates generally to user interface techniques and more specifically to a method for viewing information in a communication device.

### BACKGROUND

Mobile and fixed line telephones continue to grow in complexity and storage capacity. Such devices, for example, can store large contact books with hundreds of entries. Many phones also carry a camera, and can similarly store hundreds of media files. With access to the Internet, it is not unusual to expect that users will also view large directories such as Yellow Pages™ or corporate directories. Generally, large volumes of information such as contact books, media files, and directories are viewed sequentially, which can be a frustrating experience for consumers.

A need therefore arises for a method for viewing information in a user interface of a communication device.

### BRIEF DESCRIPTION OF THE DRAWINGS

FIG. 1 depicts an exemplary embodiment of a communication device;

FIG. 2 depicts an exemplary method operating in the communication device;

FIG. 3 depicts exemplary embodiments of the communication device;

FIG. 4 depicts an exemplary a User Interface (UI) that can be presented by a UI element of the communication device;

FIG. 5 depicts an exemplary catch and release element associated with a navigation element of the communication device;

FIG. 6 depicts an exemplary timing diagram associated with the catch and release element of FIG. 5; and

FIG. 7 depicts an exemplary diagrammatic representation of a machine in the form of a computer system within which a set of instructions, when executed, may cause the machine to perform any one or more of the methodologies disclosed herein.

### DETAILED DESCRIPTION

Embodiments in accordance with the present disclosure provide a method for viewing information in a communication device.

In a first embodiment of the present disclosure, a communication device can have a communication element that supports Voice over IP (VoIP) communications with a communication system, a User Interface (UI) element that presents a plurality of Graphical User Interface (GUI) elements for controlling operations of the communication device, and a navigation element that performs non-linear navigation between GUI elements presented by the UI element in response to detecting one or more navigation conditions.

In a second embodiment of the present disclosure, a computer-readable storage medium in a communication device can have computer instructions for presenting Graphical User Interface (GUI) elements, and performing non-linear navigation between the GUI elements presented according to an observed navigation behavior of an end user of the communication device. In this embodiment, the communication device exclusively supporting packet-switched voice services such as Voice over IP (VoIP), IP video (e.g., H.323), or IP Multimedia Subsystem (IMS) services.

In a third embodiment of the present disclosure, a method can have the step of performing non-linear navigation between GUI elements presented by a UI element of a communication device supporting voice services according to an observed navigation behavior of an end user.

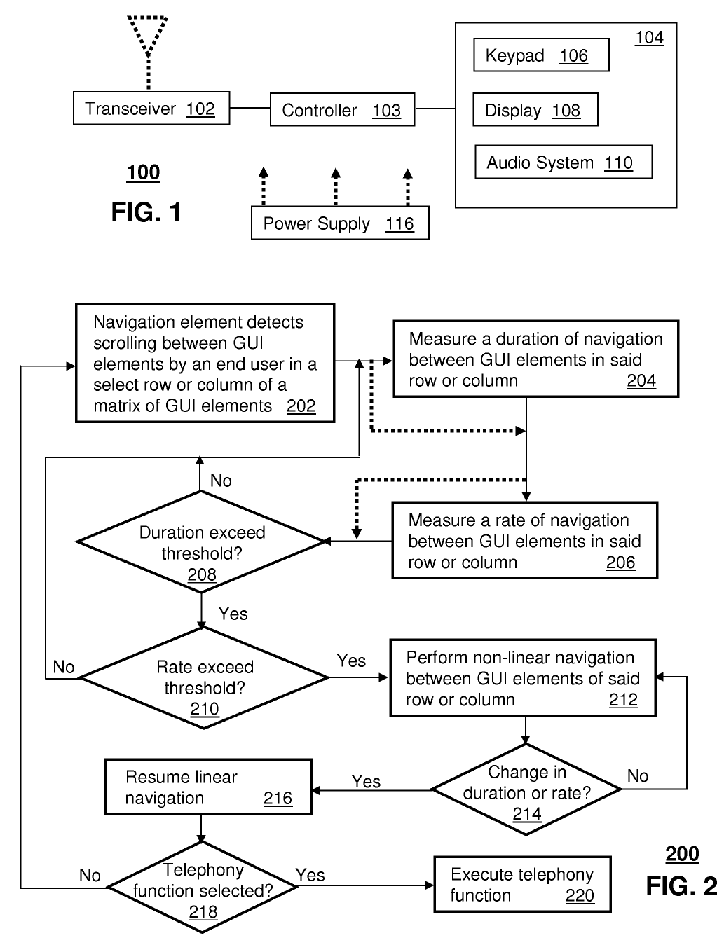

FIG. 1 depicts an exemplary embodiment of a communication device 100. The communication device 100 can comprise a wireless or wireline transceiver 102, a user interface (UI) 104, a power supply 116, and a controller 103 for managing operations of the foregoing components. The transceiver 102 can utilize common communication technologies to support singly or in combination any number of wireline access technologies such as cable, xDSL, Public Switched Telephone Network (PSTN), and so on.

Singly or in combination with the wireline technology, the transceiver 102 can support singly or in combination any number of wireless access technologies including without limitation Bluetooth™, Wireless Fidelity (WiFi), Worldwide Interoperability for Microwave Access (WiMAX), Ultra Wide Band (UWB), software defined radio (SDR), and cellular access technologies such as CDMA-1X, W-CDMA/HSDPA, GSM/GPRS, TDMA/EDGE, and EVDO. SDR can be utilized for accessing public and private communication spectrum with any number of communication protocols that can be dynamically downloaded over-the-air to the communication device 100. It should be noted also that next generation wireline and wireless access technologies can also be applied to the present disclosure.

The UI element 104 can include a keypad 106 with depressible or touch sensitive keys and a navigation element such as a navigation disk, roller ball, flywheel, joystick, touch sensitive pad, mouse, or touch-screen GUI elements of a display 108 for manipulating operations of the communication device 100. The display 108 can utilize technology such as monochrome or color LCD (Liquid Crystal Display) which can be touch sensitive for manipulating operations and for conveying images to the end user of the communication device 100. The UI element 104 can further include an audio system 110 that utilizes common audio technology for conveying and intercepting audible signals of the end user.

The power supply 116 can utilize common power management technologies such as replaceable batteries, supply regulation technologies, and charging system technologies for supplying energy to the components of the communication device 100 and to facilitate portable applications. Depending on the type of power supply 116 used, the communication device 100 can represent an immobile or portable communication device. The controller 103 can utilize computing technologies such as a microprocessor and/or digital signal processor (DSP) with associated storage memory such a Flash, ROM, RAM, SRAM, DRAM or other like technologies for controlling operations of the communication device 100.

The communication device 100 can further represent a single operational device or a family of devices configured in a master-slave arrangement. In the latter embodiment, the components of the communication device 100 can be reused in different form factors for the master and slave communication devices. Additionally, the communication device can represent a single mode device supporting exclusively packet-switched services such as VoIP, a multimode communication device supporting multiple services such as packet-switched and circuit-switched services.

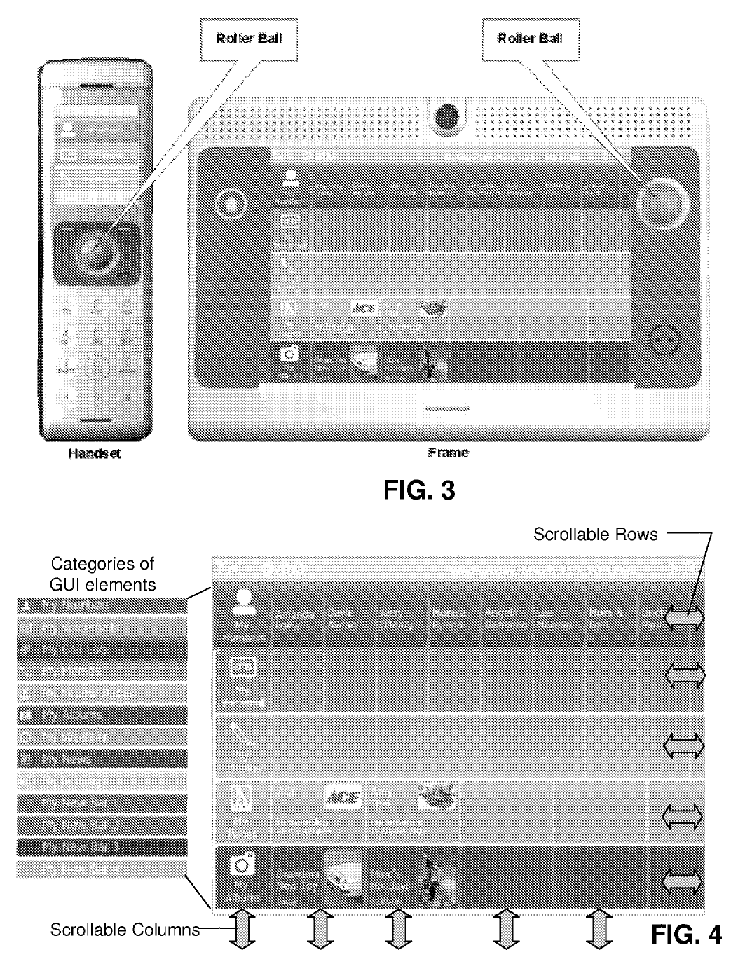

FIG. 2 depicts an exemplary embodiment of a method 200 operating in the communication device 100. Method 200 begins with step 202 in which a navigation element of the communication device 100 detects scrolling between Graphical User Interface (GUI) elements by an end user of said device in a select row or column of a matrix of GUI elements. FIG. 3 depicts two embodiments of a communication device 100. In a first embodiment, the communication device 100 can be represented by a form factor of a handset. Alternatively, or in combination with the handset (in a master-slave embodiment), the communication device 100 can be represented by a base unit or frame. In each of these embodiments, the communication device 100 includes a navigation element in the form of a roller ball.

The roller ball can be used to navigate between GUI elements in rows or columns as depicted in FIG. 4. A GUI element in general can represent any selectable entity in a user interface presented by display 108. In the illustrations of FIGS. 3-4, GUI elements are organized in categories according to a matrix of rows and columns. Each row represents a category, while each column represents a sub-GUI element associated with a select category. A category can represent any subject matter of interest to the end user of the communication device 100. Categories can thus include without limitation contact book listings, (public or employee) directory listings, task listings, memo listings, voicemail listings, call log listings (e.g., missed calls, calls dialed), multimedia listings (e.g., picture files such as JPEG files, Video files such as MPEG 4 files, and/or music files such as MPEG 3 files), news listings, weather listings, settings listings (e.g., ring tone selection, wall paper selections, etc.), and customized content listings (e.g., customized album of pictures, music, or video files).

With the roller ball, a user can scroll through sub-GUI elements in a select category. For example, in FIG. 4 the GUI category “My Numbers” represents a contact book with some of the contacts shown (e.g., “Amanda Loew,” “David Aycan,” “Jerry O'Leary”, and so on). Each of these entries in the contact book represents a GUI element. To indicate a selected GUI category, the row of GUI elements associated with said category is given three-dimensional perspective highlighted by its edges. To determine which GUI element is under review, a select one of the GUI element is highlighted by noticeable changes in its color scheme and shape. As the roller ball is moved sideways, the next GUI element is highlighted with a noticeable change in color to indicate it is under review, while the GUI element previously under review returns back to a color scheme with the other unselected GUI elements. With changes in color and three-dimensional highlights applied to each category of GUI elements, an end user can scroll through said categories with ease. Other navigation techniques such as a mouse with pointer, touch pad with pointer, and so on can be applied to the present disclosure.

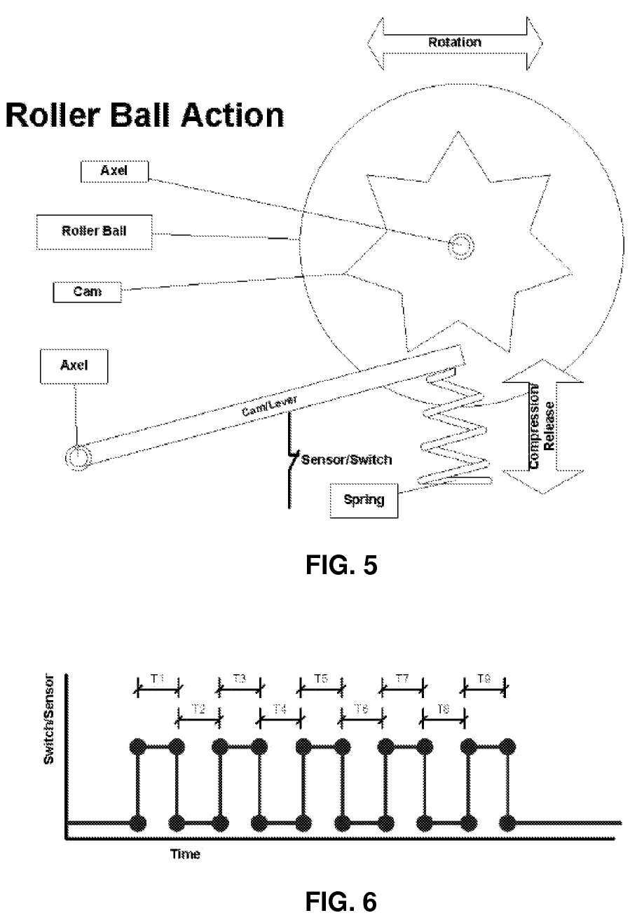

Continuing with the roller ball illustration, FIG. 5 depicts a cross-section of a catch and release element for managing the scrolling function of the communication device 100. The catch and release element utilizes common techniques for digitizing a force applied to the roller ball. In the illustrated embodiment, the roller ball includes a cam coupled to a spring loaded cam lever and switch sensor. As the roller ball rotates, it engages the cam lever which in turn causes the switch to open and close depending on the position of said lever. Each transition between teeth of the cam represents a motion from one GUI element to another. As noted earlier, navigation can be upward or downward (which represents a selection between categories), or sideways (which represents a transition between GUI elements of a selected category).

FIG. 6 illustrates timing detected by the switch sensor as the cam lever shifts between cam teeth. In this diagram transitions between cam teeth (e.g., T1-T2, T3-T4, etc.), is mostly uniform for illustration purposes only. In practice it would be expected that the transitions between cam teeth will be non-uniform depending on forces applied by the end user while moving the roller ball. With the signaling information of FIG. 6, the communication device 100 can observe the navigation behavior of the end user when navigating between rows of GUI elements (i.e., navigating between categories of GUI elements), or columns of GUI elements (i.e., navigating between GUI elements of a selected category).

Referring back to FIG. 2, once the navigation element detects that the end user is navigating between GUI elements in a row or column in step 202, the communication device 100 proceeds to step 204 where it measures a duration of navigation between GUI elements in said row or column. The duration can be a measure of a length of time in which the end user is making nearly contiguous transitions (i.e., transitions with minimal pause) between GUI elements. A nearly contiguous transition can represent transitions (T1-T2, T3-T4, and so on) having a period that reflects an on-going navigation activity by the end user (e.g., 500 ms or less period per cycle between cam teeth). A duration of navigation can be measured as a length of time consisting of contiguous timed transitions satisfying a maximum period between cam teeth. In step 206, the communication device 100 can further measure a rate of navigation between GUI element in said row or column. The rate can represent an average speed of transition between GUI elements.

Steps 204 and 206 can be used together to prevent a false trigger of a non-linear scroll function as will be described shortly. The duration of navigation measurement can be used to ignore scrolling with significant pauses or contiguous scrolling for a short duration. By measuring the duration of scroll actions by the end user, false triggering of non-linear scrolling can be avoided. The rate at which scrolling takes place can also serve to identify whether the end user is scrolling slowly (e.g., average rate of 500 ms between transitions of GUI elements) or fast (e.g., average rate of 6.7 Hz or 150 ms between transitions of GUI elements). From a slow scroll rate it can be inferred that the end user may not be interested in scrolling faster. On the other hand, from a fast scroll rate for a substantive duration, it can be inferred that the end user could make use of a non-linear fast scroll.

With these principles in mind, duration and rate thresholds can be defined to assess when non-linear navigation should be applied. For example, through quantitative and qualitative analysis of one or more focus groups of users it may be determined that an average duration of 2 seconds of nearly contiguous navigation at an average rate of transition between GUI elements of 6.7 Hz is satisfactory to most if not all end users to trigger non-linear navigation. Accordingly, once the duration and rate measurements have been made in steps 204-206, the communication device 100 can compare said measurements to the duration and rate thresholds of steps 208-210. If neither threshold is exceeded, the communication device 100 returns to step 204 and repeats the aforementioned process. If, however, both thresholds are exceeded, the communication device 100 proceeds to step 212 and performs non-linear navigation between the GUI elements of said row or column.

Non-linear navigation can represent any form of fast scrolling suitable to the present disclosure. For example, non-linear navigation can comprise an accelerate rate of navigation between the GUI elements of a row or column as in the present illustration. The accelerated rate can exceed a rate of navigation applied by the end user at the time non-linear navigation is applied. In one embodiment, the accelerated rate of navigation can speed up sequential scrolling between GUI elements (e.g., 2 times the end user's average rate of navigation measured in step 206).

Alternatively, the accelerated rate can be represented by a hop rate in which one or more sequential GUI elements are passed over and not presented by the UI element 104 during navigation. For example, a hop rate can represent skipping every other entry in a contact book while scrolling. In yet another embodiment, a hop rate can represent skipping contact book entries alphabetically, e.g., “A” to “B”, “C” to “D”, and so on. To assist the end user, the communication device 100 can be programmed to present a dynamic GUI element that indicates the contact book is being scrolled between letters of the alphabet. Once the end user reaches a letter of interest, the user would be expected to slow his/her rate of navigation. At this point, the communication device 100 in step 214 detects that the duration and/or rate measured has fallen below its threshold and thereby proceeds to step 216 where it resumes linear navigation.

If the end user, for example, stops navigation and selects a telephony function such as dialing a phone number from the contact book entry, the communication device 100 detects this selection in step 218 and proceeds to step 220 where it executes said function (e.g., dialing the selected number). Otherwise, the communication device 100 proceeds to step 202 and repeats the foregoing steps.

Upon reviewing the foregoing embodiments, it would be evident to an artisan with ordinary skill in the art that said embodiments can be modified, reduced, or enhanced without departing from the scope and spirit of the claims described below. For example, other suitable navigation techniques can be applied to the present disclosure. Additionally, other techniques for measuring a duration of navigation and/or rate of navigation can be applied to the present disclosure. Furthermore, non-linear navigation can be triggered by satisfying the duration of navigation in step 208 or the rate of navigation of step 210 and not necessarily both conditions.

These are but a few examples of how the present disclosure can be altered without departing from the scope of the claims described below. Accordingly, the reader is directed to the claims section for a fuller understanding of the breadth and scope of the present disclosure.

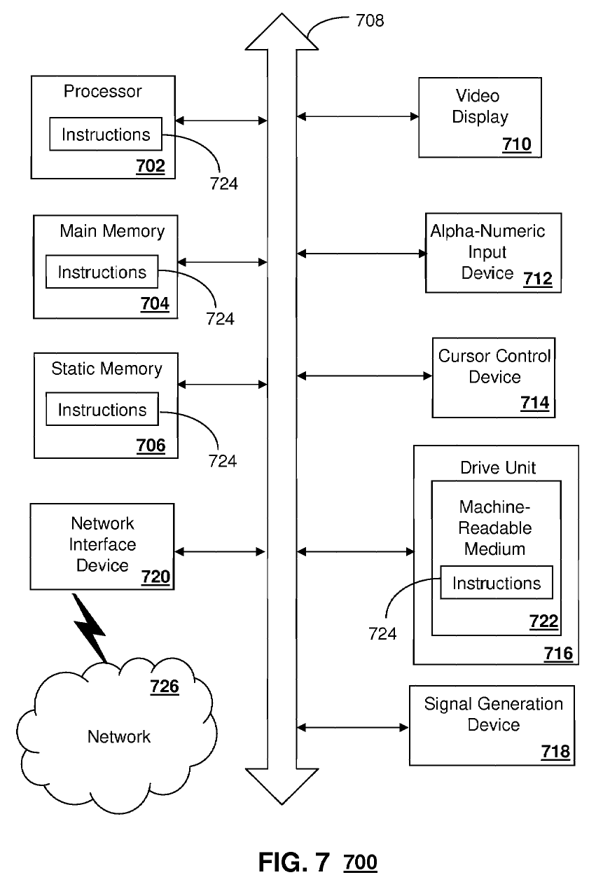

FIG. 7 depicts an exemplary diagrammatic representation of a machine in the form of a computer system 700 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 700 may include a processor 702 (e.g., a central processing unit (CPU), a graphics processing unit (GPU, or both), a main memory 704 and a static memory 706, which communicate with each other via a bus 708. The computer system 700 may further include a video display unit 710 (e.g., a liquid crystal display (LCD), a flat panel, a solid state display, or a cathode ray tube (CRT)). The computer system 700 may include an input device 712 (e.g., a keyboard), a cursor control device 714 (e.g., a mouse), a disk drive unit 716, a signal generation device 718 (e.g., a speaker or remote control) and a network interface device 720.

The disk drive unit 716 may include a machine-readable medium 722 on which is stored one or more sets of instructions (e.g., software 724) embodying any one or more of the methodologies or functions described herein, including those methods illustrated above. The instructions 724 may also reside, completely or at least partially, within the main memory 704, the static memory 706, and/or within the processor 702 during execution thereof by the computer system 700. The main memory 704 and the processor 702 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 724, or that which receives and executes instructions 724 from a propagated signal so that a device connected to a network environment 726 can send or receive voice, video or data, and to communicate over the network 726 using the instructions 724. The instructions 724 may further be transmitted or received over a network 726 via the network interface device 720.

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to email or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A communication device, comprising:
a communication element that supports Voice over IP (VoIP) communications with a communication system;
a User Interface (UI) element that presents a plurality of Graphical User Interface (GUI) elements for controlling operations of the communication device; and
a navigation element that performs non-linear navigation between GUI elements presented by the UI element in response to detecting one or more navigation conditions.

2. The communication device of claim 1, wherein the one or more navigation conditions correspond to an observed use of the navigation element by an end user of the communication device.

3. The communication device of claim 1, wherein the communication element further operates according to at least one among a Public Switched Telephone Network (PSTN) standard, a cellular communications standard, and an IP video standard.

4. The communication device of claim 1, wherein the navigation element comprises at least one among a navigation disk, a roller ball, a flywheel, a joystick, a touch sensitive pad, a mouse, and GUI elements of a touch screen display.

5. The communication device of claim 4, wherein at least one among the roller ball, and the flywheel comprise a catch and release element that digitizes a force applied to at least one among the roller ball, and the flywheel.

6. The communication device of claim 1, wherein non-linear navigation comprises an accelerated rate of navigation between GUI elements that exceeds a rate of navigation applied by an end user of the communication device.

7. The communication device of claim 6, wherein the accelerated rate of navigation between GUI elements corresponds to a hop rate between GUI elements in which one or more sequential GUI elements are passed over and not presented by the UI element during navigation.

8. The communication device of claim 1, wherein the GUI elements from which an end user navigates correspond to a category of GUI elements.

9. The communication device of claim 8, wherein the category of GUI elements comprises one among contact book listings, directory listings, task listings, memo listings, voicemail listings, call log listings, multimedia listings, news listings, weather listings, settings listings, and customized content listings.

10. The communication device of claim 1, wherein the navigation element measures a duration of nearly contiguous navigation between GUI elements, and performs non-linear navigation between the GUI elements when the duration of nearly contiguous navigation exceeds a duration threshold.

11. The communication device of claim 1, wherein the navigation element measures a duration of navigation between GUI elements, measures a rate of navigation between the GUI elements, and performs non-linear navigation between the GUI elements when the duration and rate of navigation exceed a duration threshold and a rate threshold.

12. A computer-readable storage medium in a communication device, comprising computer instructions for:
presenting Graphical User Interface (GUI) elements; and
performing non-linear navigation between the GUI elements presented according to an observed navigation behavior of an end user of the communication device, wherein the communication device exclusively supports packet-switched voice services.

13. The storage medium of claim 12, wherein the packet-switched voice services comprise at least one among Voice over IP (VoIP) services, IP video services, and IP Multimedia Subsystem (IMS) services.

14. The storage medium of claim 12, comprising computer instructions for performing non-linear navigation according to an accelerated rate of navigation between GUI elements that exceeds a rate of navigation applied by the end user to a navigation element of the communication device.

15. The storage medium of claim 14, comprising computer instructions for
performing the accelerated rate of navigation between GUI elements according to a hop rate between GUI elements in which one or more GUI elements are passed over and not presented during navigation; and
presenting a dynamic GUI element that indicates the hop rate used.

16. The storage medium of claim 12, wherein the GUI elements from which the end user navigates correspond to a category of GUI elements, wherein the category of GUI elements comprises one among contact book listings, directory listings, task listings, memo listings, voicemail listings, call log listings, multimedia listings, news listings, weather listings, settings listings, and customized content listings.

17. The storage medium of claim 12, wherein the GUI elements presented are organized in a matrix of columns and rows, and wherein the storage medium comprises computer instructions for:
measuring a duration of navigation between GUI elements in a select one of a column and a row of the GUI elements;
performing non-linear navigation between the GUI elements of said column or row when the duration of navigation exceeds a duration threshold; and
resuming linear navigation according to a navigation rate of the end user when the duration measured falls below the duration threshold.

18. The storage medium of claim 12, wherein the GUI elements presented are organized in a matrix of columns and rows, and wherein the storage medium comprises computer instructions for:
measuring a duration of navigation between GUI elements in a select one of a column and a row of the GUI elements;
measuring a rate of navigation between the GUI elements in said column or row;
performing non-linear navigation between the GUI elements of said column or row when the duration and rate of navigation exceed a duration threshold and a rate threshold; and
resuming linear navigation according to a second rate of navigation of the end user when one among the duration and rate of navigation falls below a corresponding one of the duration and rate thresholds.

19. A method, comprising performing non-linear navigation between GUI elements presented by a UI element of a communication device supporting voice services according to an observed navigation behavior of an end user.

20. The method of claim 19, wherein the communication device corresponds to at least one among a Public Switched Telephone Network (PSTN) phone, a cellular phone, a Voice over IP (VoIP) phone, and an IP video phone, and wherein the GUI elements from which the end user navigates correspond to a category of GUI elements, and wherein the method comprises performing non-linear navigation between the category of GUI elements according to an accelerated rate of navigation that exceeds a rate of navigation applied by the end user to a navigation element of the communication device.
